(19) United States
(12) Patent Application Publication
(10) Pub. No.: US 2011/0050168 A1
(43) Pub. Date: Mar. 3, 2011

(54) CHARGE CONTROL METHOD FOR VEHICLE AND DEVICE THEREOF

(75) Inventors: Jae-Jun YOO, Daejeon (KR); Seong-Ho LEE, Daejeon (KR); Jae-Chul KIM, Daejeon (KR); Yoon-Seop CHANG, Daejeon (KR); Sun-Rae PARK, Daejeon (KR)

(73) Assignee: ELECTRONICS AND TELECOMMUNICATIONS RESEARCH INSTITUTE, Daejeon (KR)

(21) Appl. No.: 12/868,026

(22) Filed: Aug. 25, 2010

(30) Foreign Application Priority Data
Aug. 27, 2009 (KR) 10-2009-0079742
Feb. 23, 2010 (KR) 10-2010-0016159

(51) Int. Cl. H02J 7/00; G06F 7/00

(52) U.S. Cl. 320/109; 701/22

(57) ABSTRACT

The present invention provides a charge control method for a vehicle that can increase efficiency in the use of limited power. The charge control method, includes: determining, by charge control device, a charging capability of a charger selected in accordance with charge request information transmitted from the vehicle among a plurality of chargers positioned in an area corresponding to the vehicle; and controlling the charger to charge the vehicle with the amount of requested power corresponding to the charge request information in accordance with the charging capability.

### CROSS REFERENCE TO RELATED APPLICATIONS

This application claims priority to Korean Patent Application No. 10-2009-0079742 field on Aug. 27, 2009 and Korean Patent Application No. 10-2010-0016159 filed on Feb. 23, 2010, the entire contents of which are herein incorporated by reference.

### BACKGROUND OF THE INVENTION

1. Field of the Invention

The present invention relates to a method of charging an electric vehicle, in particular, charge control method and device for a vehicle which can control charging of battery of a vehicle, using various information transmitted from a telematics device of the vehicle.

2. Description of the Related Art

Recently, as a variety of eco-friendly technologies have been applied to the automobile industry to reduce emission of pollutants, technologies not using an oil-based substance of the related art, such as gasoline and whale oil, but various eco-friendly substances, for example electricity or solar heat, have been developed.

Accordingly, hybrid vehicles simultaneously using electricity, and gasoline or whale oil, or electric vehicles using only electricity have been developed and produced.

As people who use hybrid vehicles or electric vehicles increase, power consumption is temporarily increased at certain time and places (or, roads) where the vehicles can run, by the drivers who charge their vehicles.

However, technologies and systems that can efficiently distribute limited power to places requiring charge are not sufficiently considered in the present national power system.

### SUMMARY OF THE INVENTION

A charge control method according to an embodiment of the present invention includes: by charge control device, determining a charging capability of a charger selected in accordance with charge request information transmitted from the vehicle among a plurality of chargers positioned in an area corresponding to the vehicle; and controlling the charger to charge the vehicle with the amount of requested power corresponding to the charge request information in accordance with the charging capability.

A charge control method for a vehicle according to another embodiment of the present invention includes: by the vehicle, estimating the amount of power demand for charging a battery from the result of monitoring the remaining amount of electricity in the battery; transmitting charge request information including the estimated amount of power demand and the position information of the vehicle to a charge control device; receiving charge reservation information corresponding to the charge request information from the charge control device; and performing authentication by being connected with a charger corresponding to the charge reservation information among a plurality of chargers positioned in a area where the vehicle is positioned and charging the battery by receiving electricity from the charger in accordance with the authentication result.

A charge control device for a vehicle according to an embodiment of the present invention includes: a determining unit that determines a charging capability of a charger selected among a plurality of chargers in an area in accordance with charge request information transmitted from the vehicle; and a control unit that controls the charger to charge the vehicle with the amount of requested power corresponding to the charge request information in accordance with the charging capability by the determining unit.

According to the charge control method and the charge control device for the method of the present invention, it is possible to efficiently and conveniently charge an electric vehicle by using geographic information and various vehicle-related information provided from the vehicle, and efficiently provide limited amount of power to a desired place and time.

### BRIEF DESCRIPTION OF THE DRAWINGS

A brief description is provided for each figure to help more fully understand the drawings cited in the detailed description of the present invention:

FIG. 1 is a schematic diagram illustrating the configuration of a charge system for a vehicle including a charge control device for a vehicle according to an embodiment of the present invention;

FIG. 2 is a diagram illustrating the schematic configuration of a determining unit of a power management block according to an embodiment of the present invention;

FIG. 3 is a diagram illustrating the schematic configuration of a determining unit of a power management block according to another embodiment of the present invention;

FIG. 4 is a flowchart illustrating a charge control operation of a vehicle according to an embodiment of the present invention, using the charge control system of a vehicle shown in FIG. 1;

FIGS. 5 and 6 are detailed flowcharts of a step of determining charge possibility; and

FIG. 7 is a flowchart illustrating a charge control operation of a vehicle according to another embodiment of the present invention, using the charge system for a vehicle shown in FIG. 1.

### DETAILED DESCRIPTION OF THE PREFERRED EMBODIMENTS

In order to fully understand benefits in the operation of the present invention and objects to be achieved by exemplary embodiments of the present invention, the accompanying drawings illustrating the exemplary embodiments of the present invention and the contents described in the accompanying drawings should be referred.

Hereinafter, the exemplary embodiment of the present invention will be described in detail with reference to the accompanying drawings to help understand the present invention. The same reference numerals designate the same component in the drawings.

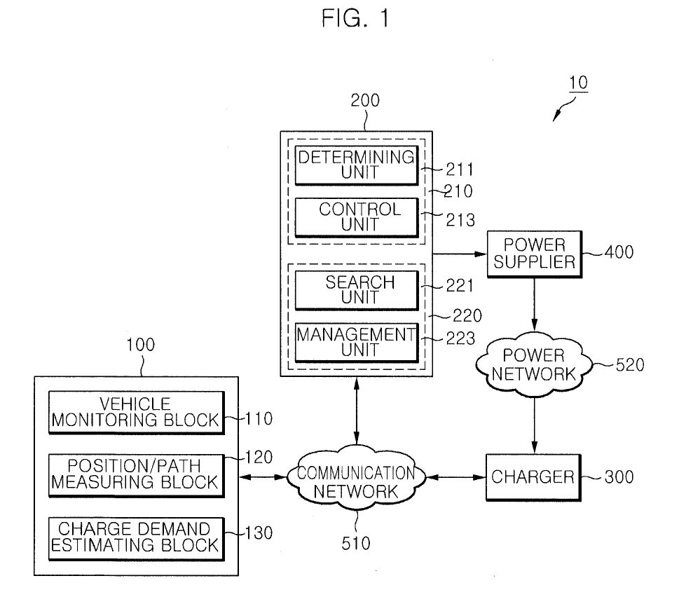

FIG. 1 is a schematic diagram illustrating the configuration of a charge control system for a vehicle including a charge control device for a vehicle according to an embodiment of the present invention.

Referring to FIG. 1, a charge system 10 for a vehicle according to the present invention may include a vehicle 100, a charge control device 200, a charger 300, and a power supplier 400.

In this configuration, the vehicle 100, the charge control device 200, and the charger 300 may be connected through a communication network 510 and communicate predetermined data with each other.

Further, the charger 300 and the power supplier 400 may be connected through a power network 520, for example, a smart grid power network, and the power supplier 400 may be controlled by the charge control device 200 to supply predetermined power to the charger through the power network 520.

The vehicle 100 may be a vehicle including a battery (not shown) therein for charging, such as an electric vehicle or a hybrid vehicle. In the vehicle 100, the battery is charged by the charger 300 and the charged electricity can be used as driving energy.

The vehicle 100 may include a monitoring block 110, a position/path-measuring block 120, and a charge demand-estimating block 130.

The vehicle-monitoring block 110 may be a battery monitor that can monitor the remaining amount of electricity in the charged battery of the vehicle 100.

The vehicle-monitoring block 110 can inform the driver that it is required to charge the battery of the vehicle 100 traveling, if it is necessary.

For example, the vehicle-monitoring unit 110 regularly monitors the remaining amount of electricity of the battery and outputs the result, and can inform the driver with a informing means, such as a warning light, that the remaining amount of electricity of the monitored battery comes close to a critical level (e.g. the minimum amount of electricity required to drive the vehicle).

The position/path-measuring block 120 may be a telematics device, such as a GPS (Global Positioning System) or a navigation device equipped in the vehicle 100.

The position/path-measuring block 120 measures the current position, traveling path, and destination information of the vehicle 100 traveling, and informs the measured result to the driver or transmits it to the charge control device 200 through the communication network 510.

The charge demand-estimating block 130 can estimate and output the amount of electricity for charging the battery, that is the amount of charge demand, in accordance with the monitored result outputted from the vehicle-monitoring block 110.

The charge demand-estimating block 130 can estimate the amount of charge demand on the basis of the vehicle information, for example, the weight and output of the vehicle.

When the battery requires to be charged, the vehicle 100 can transmit charge request information, for example charge request information including the estimated amount of charge demand, vehicle position information, or vehicle traveling path information to the charge control device 200 through the communication network 510.

Further, the vehicle 100 can transmit charge request information to the charger 300 by being connected to a specific charger, for example, the charger 300 selected by the driver. The charger 300 can transmit the charge request information transmitted from the vehicle 100 to the charge control device 200 through the communication network 510.

The charge control device 200 can control one of a plurality of charges in the area where the vehicle 100 is located to charge the vehicle 100, on the basis of the charge request information transmitted from the vehicle 100 or the charger 300.

For example, the charge control device 200 can divide the district to manage into a plurality of areas and select one area corresponding to the position information, for example the position information of the vehicle 100 or the position information of the charger 300, included in the charge request information transmitted through the communication network 510.

Further, it can detect and select the charger 300 from the chargers in the selected area or control the charger 300 selected by the vehicle 100 to charge the vehicle 100.

The charge control device 200 can divide the desired district into a plurality of areas, using a digital map or network information, and manages the divided areas as geographic information. Position information of the chargers can be included in the divided areas.

The charge control device 200 can include a power management block 210 and a charge management block 220.

The power management block 210 can include a determining unit 211 and a control unit 213.

The determining unit 211 of the power management block 210 can determined a charging capability of a corresponding charger 300, on the basis of the received charge request information. The charging capability corresponds to whether the charger 300 can perform charging or not.

The control unit 213 of the power management block 210 can generate a control signal in accordance with the result determined by the determining unit 211. The generated control signal can be outputted to the charge management block 220 or the power supplier 400 to control the charging operation of the charger 300.

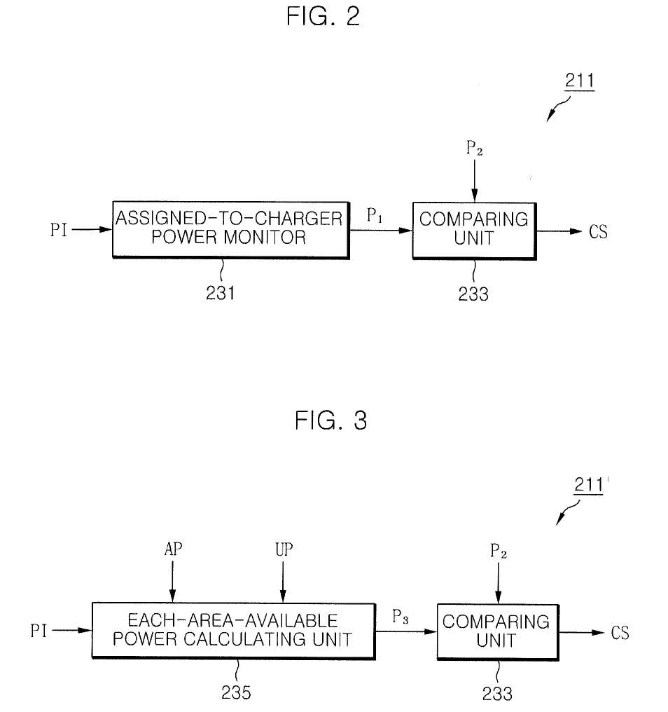

FIG. 2 is a schematic diagram illustrating the configuration of the determining unit of the power management block according to an embodiment of the present invention and FIG. 3 is a schematic diagram showing the configuration of a determining unit of a power management block according to another embodiment of the present invention.

Referring to FIGS. 1 and 2, the determining unit 211 of the power management block 210 can include an assigned-to-charger power monitor 231 and a comparing unit 233.

The assigned-to-charger power monitor 231 can output the amount of power P1 assigned to the charger 300 of the area corresponding to the position information PI included in the charge request information transmitted through the communication network 510, for example, the position information of the vehicle 100 or the charger 300.

The comparing unit 233 can compare the request amount of power P2 included in the charge request information, that is, the amount of charge demand estimated by the charge demand-estimating block 130 of the vehicle 100 with the amount of assigned power P1 of the charge outputted from the assigned-to-charger power monitor 231, and then output the compared result CS.

The determining unit 213 of the power management block 210 can generate a control signal in accordance with the compared result CS outputted from the comparing unit 233 of the determining unit 211 and can output the generated control signal to the charge management block 220 (described below) or the power supplier 400.

Referring to FIGS. 1 and 3, the determining unit 211′ of the power management block 210 can include an each-area-available power calculating unit 235 and a comparing unit 233.

The each-area-available power calculating unit 235 can estimate and output the amount of available power P3 of the area corresponding to the position information PI included in the charge request information received through the communication network 510.

For example, the each-area-available power calculating unit 235 can estimate the amount of available power P3 from the amount of assigned power AP and the amount of used power UP of the area corresponding to the position information PI.

The comparing unit 233 can compare the estimated amount of available power P3 with the requested amount of requested power P2 and output the compared result CS.

The determining unit 213 can generate a control signal in accordance with the compared result CS outputted from the comparing unit 233 and can output the generated control signal to the charge management block 220 or the power supplier 400.

Referring to FIG. 1 again, the charge management block 220 of the charge control device 200 may include a search unit 221 and a management unit 223.

When the vehicle 100 transmits charge request information through the communication network 510, the search unit 221 detects and selects an optimal charger 300 in accordance with the position information of the vehicle 100 and then outputs it to the management unit 223.

For example, the search unit 221 can extract one area corresponding to the position information of the vehicle 100 from the areas, and then search and select the charger 300 closest to the current position of the vehicle 100 from the chargers 300 in the extracted area.

The information about the charger 300 selected by the search unit 221, for example, the location information of the charger 300 can be outputted to the management unit 223.

Further, when the vehicle 100 transmits the charge request information through the charger 300, the search unit 221 may extract the location information of the charger 300 and output it to the management unit 223.

The management unit 223 can transmit a charge start command or perform a charge reservation to the charger 300, in response to the charger information transmitted from the search unit 221 and the control signal transmitted from the power management unit 210.

For example, the management unit 223 can perform charge reservation to the charger 300 corresponding to the charger information transmitted from the search unit 221 where the vehicle 100 does not reach the charger 300 yet, that is, when the charge request information is transmitted from the vehicle 100 through the communication network 510.

The management unit 223 can transmit charge demand information to the charger 300 and the charge demand information can include the vehicle ID information and the requested-power amount information.

Further, the management unit 223 can transmit the charge reservation information including the position information of the charger 300 to the vehicle 100 and the driver can switch to the charger 300 corresponding to the transmitted charge reservation to charge it.

Meanwhile, the management unit 223 can transmit a charge start command to the charge 300 corresponding to the charger information transmitted from the search unit 221 when the vehicle 100 reaches the charger 300, that is, the charge request information is transmitted from the charger 300 through the communication network 510.

The charger 300 can charge the vehicle 100 with the amount of requested power in accordance with the charge start command transmitted from the charge management block 220 of the charge control device 200, or perform charge reservation in accordance with the charge demand information transmitted from the charge management block 220 and then charge with the requested amount of power when the vehicle 100 reaches the charger 300.

The charger 300 stores the charge demand information, such that it can authenticate the vehicle 100, using the stored charge demand information when the vehicle 100 reaches the charger, and then charge the vehicle 100.

The power supplier 400 may be a transformer substation or a power plant in the district managed by the charge control device 200, and can supply the charger 300 with predetermined power in response to the control signal transmitted from the charge control device 200.

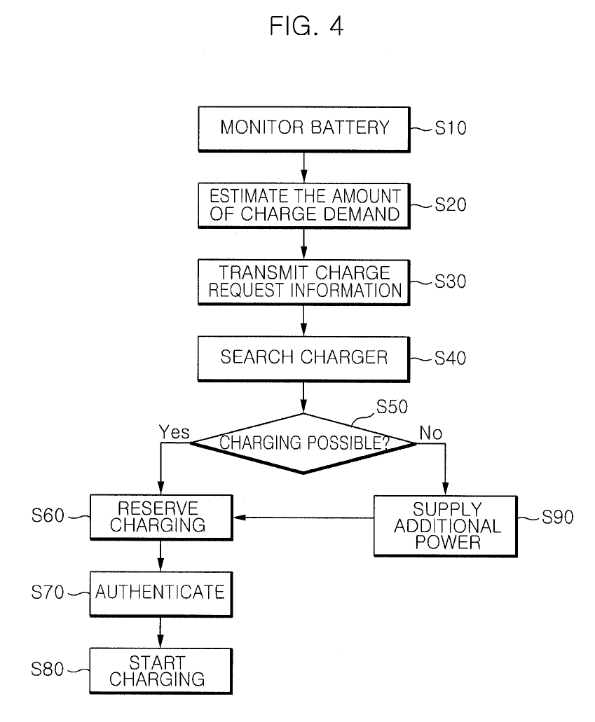

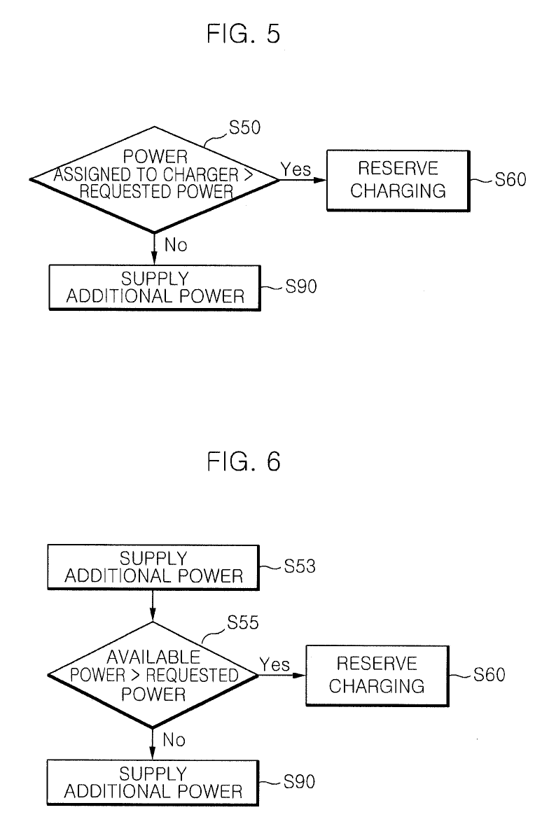

FIG. 4 is a flowchart illustrating a charge control operation of a vehicle according to an embodiment of the present invention, using the charge control system shown in FIG. 1, and FIGS. 5 and 6 are detailed flowcharts of a step of determining charge possibility.

Hereinafter, the charge control operation when charge request information is transmitted from the vehicle 100 to the charge control device 200 through the communication network 510 is described with reference to FIGS. 1 to 6.

Referring to FIGS. 1 to 3, the vehicle-monitoring block 110 of the vehicle 100 traveling can monitor the remaining amount of electricity in the battery and inform the result to the driver (S10).

When the driver recognizes that charge is required, from the monitored result, the charge demand-estimating block 130 of the vehicle 100 can estimate the required amount of charge demand power (S20).

Thereafter, it can generate charge request information from the position information and path information of the vehicle outputted from the position/path-measuring block 120 of the vehicle 100 and the amount of charge demand power estimated from the charge demand-estimating block 130, and transmit the generated charge request information to the charge control device 200 through the communication network 510 (S30).

The charge management block 220 of the charge control device 200 can detect and select the charger 300 closest to the vehicle 100 from the chargers in the district corresponding to the current position of the vehicle 100, in accordance with the charge request information transmitted from the charge management block 220 (S40).

Further, the power management block 210 can determine charge possibility of the charger 300 selected by the charge management block 220 in accordance with the charge request information transmitted from the power management block 210 (S50).

Referring to FIGS. 1, 2, and 5, the determining unit 211 of the power management block 210 can include an assigned-to-charger power monitor 231 and a comparing unit 233.

The assigned-to-charger power monitor 231 can monitor and output the amount of power P1 assigned to the detected charger 300.

The comparing unit 233 can compare the amount of assigned power P1 of the charger 300 with the amount of request power P2 according to the charge request information, and output the compared result CS (S51).

The control unit 213 can generate and output a control signal in accordance with the compared result CS outputted from the comparing unit 233.

For example, when the amount of assigned power P1 is larger than the amount of request power P2, as a result of the comparison in the comparing unit 233, the control unit 213 generates a control signal in accordance with the compared result CS outputted from the comparing unit 233 and can output the control signal to the management unit 223 of the charge management block 220.

The management unit 223 can transmit charge request information to the detected charger 300 in response to the control signal outputted from the control unit 213. Further, it can perform charge reservation by transmitting charge reservation information including the position information of the charger 300 to the vehicle 100 (S60).

The charge demand information can include vehicle ID information or requested-power amount information included in the charge request information transmitted from the vehicle 100.

For example, when the amount of assigned power P1 is smaller than or the same as the amount of request power P2, as a result of the comparison in the comparing unit 233, the control unit 213 generates a control signal in accordance with the compared result CS outputted from the comparing unit 233 and can output the control signal to the power supplier 400.

The management unit 400 can supply additional power to the detected charger 300 in response to the control signal outputted from the control unit 213 (S90).

In this configuration, the amount of additional power supplied from the power supplier 400 to the charger 300 may be the same as the amount of requested power P2 from the vehicle 100.

When the supply of additional power from the power supplier 400 to the charger 300 is finished, the management unit 223 of the charge management block 220 can transmit charge demand information to the charger 300. Further, it can perform charge reservation by transmitting charge reservation information including the position information of the charger 300 to the vehicle 100 (S60).

Referring to FIGS. 1, 3, and 6, the determining unit 211 of the power management block 210 can include an each-area-available power calculating unit 235 and a comparing unit 233.

The each-area-available power calculating unit 235 can calculate surplus power at the area where the detected charger 300 is positioned, that is, the amount of available power (S53).

For example, the each-area-available power calculating unit 235 receives the amount of each area-assigned power AP and the amount of each area-used power UP, and can calculate the amount of area-available power P3 from the above amounts of power. The amount of area-available power P3 can be calculated by subtracting the amount of each area-used power UP from the amount of each area-assigned power AP.

The comparing unit 233 can compare the estimated amount of available power P3 with the amount of requested power P2 and output the compared result CS (S55).

The control unit 213 can generate and output a control signal in accordance with the compared result CS outputted from the comparing block 233.

For example, when the amount of available power P3 is larger than the amount of request power P2, as a result of the comparison in the comparing unit 233, the control unit 213 generates a control signal in accordance with the compared result CS outputted from the comparing unit 233 and can output the generated control signal to the management unit 223 of the charge management block 220.

The management unit 223 can transmit charge request information to the detected charger 300 in response to the control signal outputted from the control unit 213. Further, it can perform charge reservation by transmitting charge reservation information including the position information of the charger 300 to the vehicle 100 (S60).

The charge demand information can include vehicle ID information or requested-power amount information included in the charge request information transmitted from the vehicle 100.

For example, when the amount of available power P3 is smaller than or the same as the amount of request power P2, as a result of the comparison in the comparing unit 233, the control unit 213 generates a control signal in accordance with the compared result CS outputted from the comparing unit 233 and can output the generated control signal to the power supplier 400.

The management unit 400 can supply additional power to the corresponding area in response to the control signal outputted from the control unit 213 (S90).

In this configuration, the amount of additional power supplied from the power supplier 400 to the corresponding area may be the same as the amount of requested power P2 from the vehicle 100.

When the supply of additional power from the power supplier 400 to the corresponding area is finished, the management unit 223 of the charge management block 220 can transmit charge demand information to the charger 300. Further, it can perform charge reservation by transmitting charge reservation information including the position information of the charger 300 to the vehicle 100 (S60).

Referring to FIGS. 1 to 3 again, when charge reservation for the vehicle 100 is completed by the management unit 223, the driver can drive to a designated charger, that is, the detected charger 300, on the basis of the charge reservation transmitted from the charge control device 200, and connect the vehicle 100 to the charger 300.

The charger 300, as described above, stores charge demand information including the ID information of the vehicle 100 and the amount of request power, and can authenticate the vehicle, using the charge demand information stored in the vehicle 100 when the vehicle 100 reaches the charger (S70).

Thereafter, when the vehicle is authenticated, the charger 300 starts charging to charge the vehicle 100 with the amount of requested power P2 according to the charge demand information (S80).

Further, when the charger 300 finishes charging the vehicle 100, the charger 300 can transmit the charging result to the charge control device 200 and the charge control device 200 can store the result. The stored charging result can be periodically updated.

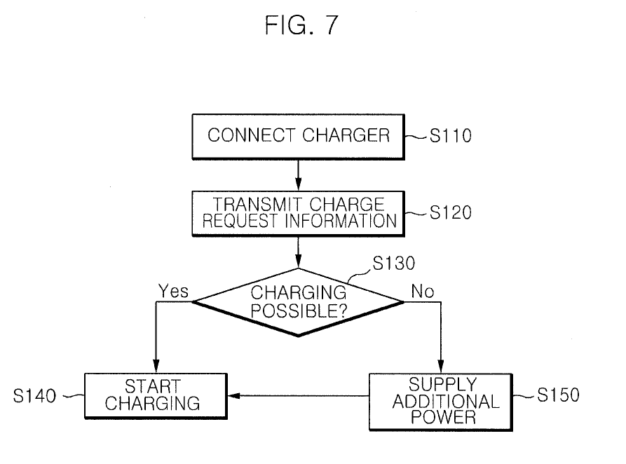

FIG. 7 is a flowchart illustrating a charge control operation of a vehicle according to another embodiment of the present invention, using the charge system for a vehicle shown in FIG. 1.

Hereinafter, a charge control operation when the vehicle 100 connects with a specific charger 300 and then transmits charge request information to the charge control device 200 through the charger 300 is described in detail with reference to FIGS. 1 to 3, and 5.

Referring to FIGS. 1 and 5, when the driver connects with a specific charger that he/she sees in driving, for example, the charger 300 among a plurality of chargers in an area and requests charging (S110), the charger 300 can transmit the charge request information transmitted from the vehicle 100 and its position information to the charge control device 200 (S120).

The power management block 210 of the charge control device 200 can determine whether charging is possible, in accordance with the charge request information and the charger position information transmitted from the charger 300 (S130).

For example, the determining unit 211 of the power management block 210, as described above with reference to FIGS. 2 and 5, can determine whether charging is possible, by comparing the amount of assigned power P1 assigned to the charger 300 with the amount of requested power P2 from the vehicle 100.

Further, the determining unit 211 of the power management block 210, as described above with reference to FIGS. 3 and 6, can determine whether charging is possible, by calculating the amount of available power P3 in the area where the charger 300 is positioned with the amount of request power P2.

When it is determined that the charger 300 can perform charging by the determining unit 211 of the power management block 210, the control unit 213 can output a control signal generated by the charging capability to the management unit 223 of the charge management block 220.

The management unit 223 transmits a charge start command to the charger 300 in response to the control signal and the charger 300 can charge the vehicle 100 with the amount of request power P2 in accordance with the charge start command (S140).

Meanwhile, when it is determined that the charger 300 cannot perform charging by the determining unit 211 of the power management block 210, the control unit 213 can output a control signal generated by the charging capability to the power supplier 400.

The power supplier 400 can supply additional power to the charger 300 or the area where the charger 300 is positioned, in response to the control signal (S150).

In this configuration, the amount of additional power supplied from the power supplier 400 may be the same as the amount of requested power P2 from the vehicle 100.

When additional power supply to the charger 300 or the area is finished, the management unit 223 of the charge management block 220 transmits a charge start command to the charger 300 and the charger 300 can charge the vehicle 100 with the amount of requested power P2 in accordance with the charge start command (S140).

Further, when the charger 300 finishes charging the vehicle 100, the charger 300 can transmit the charging result to the charge control device 200 and the charge control device 200 can store the result. The stored charging result can be periodically updated.

Although the present invention was described with reference to an embodiment shown in the figure, it is not limited thereto and can be modified in various equivalent embodiments by those skilled in the art. Accordingly, the actual technical protection scope of the present invention must be determined by the spirit of the appended claims.

What is claimed is:

1. A charge control method for a vehicle, comprising:
determining, by charge control device, a charging capability of a charger selected in accordance with charge request information transmitted from the vehicle among a plurality of chargers positioned in an area corresponding to the vehicle; and
controlling the charger to charge the vehicle with the amount of requested power corresponding to the charge request information in accordance with the charging capability.

2. The charge control method for a vehicle according to claim 1, wherein the determining comprises comparing the amount of assigned power of the charger with the amount of requested power, and then determining the charging capability in accordance with the compared result.

3. The charge control method for a vehicle according to claim 2, wherein the determining further comprises:
controlling the charger to charge the vehicle with the amount of requested power when the amount of assigned power of the charger is larger than the amount of requested power; and
supplying additional power to the charger and then controlling the charger to charge the vehicle with the amount of requested power when the amount of assigned power of the charger is smaller than or the same as the amount of requested power.

4. The charge control method for a vehicle according to claim 3, wherein the additional power is supplied to the charger in the same amount of power as the amount of requested power.

5. The charge control method for a vehicle according to claim 1, wherein the determining comprises transmitting a charge start command to the charger in accordance with the charging capability when the vehicle reaches the charger, or performing a charge reservation by transmitting charge demand information to the charger in accordance with the charging capability when the vehicle does not reach the charger yet.

6. The charge control method for a vehicle according to claim 5, further comprising transmitting charge reservation information including position information of the charger to the vehicle after performing the charge reservation.

7. The charge control method for a vehicle according to claim 6, further comprising authenticating the vehicle by comparing the charge demand information stored in the charger with the charge reservation information stored in the vehicle when the vehicle reaches the charger after the charge reservation is made.

8. The charge control method for a vehicle according to claim 1, wherein the determining includes:
calculating the amount of available power from the amount of assigned power to the area and the amount of used power of the area where the charge is positioned; and
comparing the amount of available power with the amount of requested power and then determining the charging capability in accordance with the compared result.

9. The charge control method for a vehicle according to claim 8, wherein the determining further includes:
controlling the charger to charge the vehicle with the amount of requested power when the amount of available power is larger than the amount of requested power; and
supplying additional power to the area and then controlling the charger to charge the vehicle with the amount of requested power when the amount of available power is smaller than or the same as the amount of requested power.

10. The charge control method for a vehicle according to claim 1, wherein the charge request information further includes position information of the vehicle, and
the charger is a charger detected and selected adjacent to the vehicle in accordance with the position information among the chargers positioned in the area.

11. The charge control method for a vehicle according to claim 1, wherein the charger is selected as a charger that the vehicle is connected to, among the chargers positioned in the area.

12. A charge control method for a vehicle, comprising:
estimating, by the vehicle, the amount of power demand for charging a battery from a result of monitoring the remaining amount of electricity in the battery;
transmitting charge request information including the estimated amount of power demand and position information of the vehicle to a charge control device;
receiving charge reservation information corresponding to the charge request information from the charge control device; and
performing an authentication by being connected with a charger corresponding to the charge reservation information among a plurality of chargers positioned in an area where the vehicle is positioned and charging the battery by receiving electricity from the charger in accordance with the authentication result.

13. A charge control device for a vehicle comprising:
a determining unit that determines a charging capability of a charger selected in accordance with charge request information transmitted from the vehicle among a plurality of chargers in an area; and
a control unit that controls the charger to charge the vehicle with the amount of requested power corresponding to the charge request information in accordance with the charging capability.

14. The charge control device for a vehicle according to claim 13, wherein the determining unit compares the amount of assigned power of the charger with the amount of requested power and determines the charging capability in accordance with the compared result.

15. The charge control device for a vehicle according to claim 14, wherein the control unit controls the charger to charge the vehicle with the amount of requested power when the amount of assigned power of the charger is larger than the amount of requested power, and supplies additional power to the charger when the amount of assigned power of the charger is smaller than or the same as the amount of requested power, as a result of the comparison by the determining unit.

16. The charge control device for a vehicle according to claim 15, wherein the control unit outputs a power request signal to a power supplier connected to the charger through a power network, and
the power supplier supplies the additional power having the same amount of power as the amount of requested power to the charger in response to the power request signal.

17. The charge control device for a vehicle according to claim 13, wherein the determining unit estimates the amount of available power from the amount of assigned power and the amount of used power of the area where the charger is positioned, and determines the charging capability by comparing the estimated amount of available power with the amount of requested power.

18. The charge control device for a vehicle according to claim 17, wherein the control unit controls the charger to charge the vehicle with the amount of requested power when the amount of available power of the charger is larger than the amount of requested power, and supplies additional power to the area when the amount of available power of the charger is smaller than or the same as the amount of requested power, as a result of the comparison by the determining unit.

19. The charge control device for a vehicle according to claim 13, further comprising a charge management block detecting and selecting the charger from the chargers in accordance with the charge request information, and performing charge reservation to the charger by the control of the control unit.

20. The charge control device for a vehicle according to claim 19, wherein the charge management block transmits charge demand information to the charger, and performs charge reservation by transmitting charge reservation information including position information of the charger to the vehicle.
